(19) United States
(12) Patent Application Publication
(10) Pub. No.: US 2010/0076724 A1
(43) Pub. Date: Mar. 25, 2010

(54) Method for capturing and analyzing test result data

(76) Inventors: Harold Lee Brown, Phoenix, AZ (US); Phillip A. Justice, Holiday, FL (US)

Correspondence Address: The Halvorson Law Firm, Ste 130, 1757 E. Baseline Rd., Gilbert, AZ, 85233, US

(21) Appl. No.: 12/284,560

(22) Filed: Sep. 23, 2008

(51) Int. Cl. G06F 17/18

(52) U.S. Cl. 702/179

(57) ABSTRACT

A method, system, and graphical user interface display for an efficient and effective characterization and analysis of test data for diverse products from a wide variety of industries using both successful test data and failure test data.

### FIELD OF THE INVENTION

The present invention relates to the field of capturing, characterizing, calculating, evaluating, and analyzing test data.

### BACKGROUND

Design and Manufacturing companies typically utilize test instruments, manual test equipment, and/or automated test equipment (“test equipment”) with specific test software to validate a product design and manufacturing process.

The test equipment usually has associated hardware interfacing between the test equipment and the products under test. Such products may include, but are not limited to, one or more of the following: devices, printed circuit assemblies, sub-assemblies, sub-units, units, sub-systems, and/or systems. The types of data and/or parameters collected from these products will vary depending upon the type of product. Some typical data and/or parameters include, but are not limited to, voltage, current, resistance, frequency, magnetic flux, digital data, dimensional, thermal properties, temperature, vibration, oil properties, machine alignment, and other measurable/operational data.

In the past, fielded products exhibited severe problems. The failure data for these products simply did not uncover all of the design or manufacturing problems. In fact, it was later discovered that the failure data lead to incorrect diagnosis of the core problems.

In order to resolve this, it was decided to characterize and evaluate a large sample of all the product test parameters to determine if the core problems were detectable. All test measurement data underwent a preliminary evaluation. The preliminary evaluation revealed some but not all of the core problems. Hence, more statistical analysis was added in the evaluation of the parameters. The problematic parameters underwent this reevaluation, which confirmed the root cause of the problems and ultimately led to improved product performance.

Statistical values are based on averages for each of the actual test data and/or parameters, allowing the opportunity to drive continuous improvement into the product design, measurement technique, affiliated test equipment design and process, and manufacturing process, and launch products that have optimized tolerance allocations thus reducing or eliminating defects. Both success data and failure data are used in the capture, characterization, calculation, and evaluation/analysis in the present invention.

Currently, there is a need to characterize and analyze all data, success data and failed data, rather than checking failure data only. As full-scale diagnosis becomes more prevalent, the disadvantages and deficiencies of the system and method for evaluating failure data alone have been realized. Evaluating all data provides a complete diagnosis of the product with respect to its reliability. To meet this need, the present invention uses a process to identify and sort data and/or parameters to ascertain which data and/or parameter requires enhancement. This process ultimately provides the opportunity to make the product more robust. Not only will the process detect engineering issues as stated, the process could be used as an important predictive tool that would evaluate other factors (data and/or parameters) such as medical data, performance metrics, raw material, and financial performance.

The data and/or parameters generated under test usually require further analysis. Normally there is a plurality of products used to achieve satisfactory results, which includes, but is not limited to, statistical analysis, validating performance metrics, and the like.

### SUMMARY OF THE INVENTION

It is an object of the present invention to capture, characterize, calculate, evaluate/analyze a product design, test process, manufacturing process, raw material extraction, service industry, technological research, and so on. This evaluation will typically indicate where a design, a process, and/or a manufacturing/test process could be improved.

It is another object of the present invention to provide a method that may be performed by an embodiment combining software, hardware, and user input. This embodiment includes a computer, software embodying an analysis system or method and utilizing a graphical user interface display for test data capture, characterization, calculation, evaluation/analysis. The method entails the acquisition and characterization of test data, calculating statistical results based on this test data, thereby makes it possible for the user to assess the aggregate data and reduce the investigation to the significant parameters. An enormous amount of data can be harvested to perform the analysis of the parameters using this method.

It is yet another object of the present invention to provide aspects of the present invention that take the form of a computer program product (software) having computer-readable program code embodied in a computer-readable storage medium. Any suitable computer-readable medium may be utilized, including but not limited to, hard disks, CD-ROMs, flash drive, jump drive, or other storage devices.

It is still yet another object of the present invention to provide a method for collecting, characterizing, calculating, evaluating, and analyzing existing or newly acquired test data. The method includes inputting the data and/or parameters, performing a calculation on the data and/or parameters, processing that data and/or parameters into Random Access Memory (RAM), and displaying the statistical analysis results in a graphical user interface (GUI) for evaluation and analysis. Each data and/or parameter includes the statistically calculated output based on the test data mean and standard deviation.

It is a further object of the present invention is to provide a system that includes an input device for inputting requested information, a data storage unit, a graphical user interface display, and a method to export data externally. The data is parsed and stored in the data storage unit based on requested information. In turn, the data in the data storage unit is retrieved, parametric averages are calculated and stored in random access memory (RAM), and a graphical user interface displays the statistical values based on the parametric averages. The graphical user interface will typically display the test number, test description, units, lower specification limit, upper specification limit, mean, standard deviation, lower Z-Score value, upper Z-Score value, yield, defects per unit, sigma shift factor, and parts per million values. The calculated results displayed are different for qualitative (attribute) data and quantitative (continuous) data.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a top-level view of the process flowchart method of characterizing and analyzing test data, calculating statistical results, and displaying them via a graphical user interface.

FIG. 2a through 2e is a process flowchart illustrating the detailed steps of the present invention.

FIG. 3a and 3b is a partial sample of the individual scorecard.

FIG. 4a and 4b is a partial sample of a grouped scorecard.

### DESCRIPTION OF PREFERRED EMBODIMENTS

The present invention is useful for capturing, characterizing, and analyzing test data. More specifically, the present invention provides a method for an improved statistical analysis of test data for diverse products from a wide variety of industries, such as proctologic video probes, video bore scopes, aviation electronic surveillance units, power supply printed circuit boards, aviation information management system modules, flight data recorders, traffic collision avoidance systems, radar modules, and website performance metrics. While statistical analysis is typically used to characterize and analyze products, it can also be used to evaluate the repeatability and reproducibility of designs, test processes (test instrument or test equipment), manufacturing processes, performance metrics, raw materials, and so on.

One of the challenges facing technicians, engineers, statisticians, and the like, is to quickly analyze raw and processed data and make sound decisions based on that analysis. Statistical analysis is typically used to characterize and analyze data. By providing a reference value as a “scorecard analysis” these decisions are facilitated, thereby enabling the engineer or other personnel to more quickly evaluate, understand and communicate the status of the data being evaluated.

In accordance with the present invention, and by use of a microprocessor-based system using an appropriately configured computer program, a test scorecard is produced. The scorecard can show the evaluation of a product, product test software, test measurement instrument, test measurement equipment, service, raw material, and so on.

In summary, it is important to understand the cumulative sum of the statistical values and how they predict the reliability of the product, test measurement technique, test instrument, test equipment, and associated hardware and/or software, etc. This information is used to perform test data parameter characterization and analysis, and allows the user to make the necessary adjustments to the product being tested.

The method and system of this invention can be applied to any type of data with at least two of the same data parameters. This method also evaluates parameters over time. Thus, the invention advantageously facilitates parameter characterization and analysis, thereby allowing tester to address those parameters in the most need of corrective action.

Data Capture

In this method data are collected, preferably electronically. There are two types of data: attribute data, which are data that do not change over time and continuous data, which are data that change over time.

Test data should be collected in a cyclical fashion whereby the data is collected at set intervals. It would be prudent to establish sampling intervals that ensure the integrity of the design, test measurement, test equipment, and manufacturing process in an ongoing basis. Typically intervals are often set arbitrarily based on the intuition of an engineer. It is preferred to establish an initial sampling time interval on a recurring monthly basis and measure its effectiveness. By simply examining this information over time, the engineer will be able to evaluate and re-establish the sampling interval for each product.

The data may be collected on hard copy or stored in electronic media (i.e. CD, DVD, optical devices, flash drives, USB device, etc.) Test data may include, but are not limited to, information related to any measurement such as voltage, current, resistance, frequency, magnetic flux, digital data, dimensions, thermal properties, temperature, vibration frequency and amplitude, oil properties, machine alignment, and other measurable/operational information. The test data may indicate a test number, test description, test limits, and actual measured values.

Data Parsing

Preferably measured test data are processed and parsed for each of the following parameters: test specification high limits, test specification low limits, and actual measured values in conjunction with an applicable test number, test description, and measurement units (i.e. volts DC, volts AC, Ohms, current, frequency, etc. as appropriate) and entered into a data storage unit.

Manually collected data is entered into a standardized format and processed through a generic parser. However, uniquely designed and developed parsers may be used to process manual data in lieu of the generic parser.

Storage Unit

During or after the parsing operation, the parsed test data is entered into a data storage unit in a database format having a standard structured format that permits efficient characterization and analysis. Once stored this data is retrieved from the data storage unit for further processing. Typically, storage of the data in the data storage unit is temporary, however, after parsing, data may be stored externally for archival purposes.

Statistical Analysis Software

A Statistical Analysis Software (SAS) characterizes and analyzes the test data. The SAS derives single or multiple scorecards depending on the selections: all data or passed data only process method selection and individual or grouped scoring method selection as well as how many different products are selected for processing. It does not simply characterize and evaluate failure data. The uniqueness of the method according to the present invention is how it uses both successful data and failure data (non-bias software) to characterize and evaluate the test data and how it prepares the data for analysis. By combining successful data with failure data, the SAS provides an opportunity for product improvement rather than mere resolution of failures.

Once the test data is captured, parsed and stored into the data storage unit, the SAS processes each parameter against identified upper and lower specification limits, as applicable, to calculate mean and standard deviations. The mean and standard deviations, in turn, help determine statistical values based on the average of the measured values to establish the statistical capability: for continuous data the mean and standard deviation typically calculate lower Z-score, upper Z-score, yield, and defects per unit; for attribute parameters the defects per unit and parts per million are typically calculated; and the following statistical values for all parameters are calculated: average parameter long term sigma score, average parameter short term sigma score, and total defects per unit.

Defects per unit (DPU) are a calculation of the number of defects that may occur on an average unit. DPU is the total number of defects in a sample divided by the total number of units sampled for each parameter. Statistical capability analysis using the defects per unit reveals how well the process or products meets specifications and provides insight into how to improve the process or product and sustain improvements.

There are occasions where average values are not necessarily reliable due to distortions, bad readings, and stopped processes, etc. This problem can be overcome during analysis of the parameters through the elimination of faulty readings and measurements. The elimination of the faulty readings and measurements is typically accomplished by the user when capturing the data. Therefore, it is imperative that the user peruse the data files to ensure the integrity of the data prior to characterizing them using the SAS.

Scorecard Analysis Processing

After statistical processing, the user selects a scoring method and number of scorecards created by the SAS. In accordance with the present invention, the user may evaluate either all test data or only test data that falls within identified upper and lower specification limits. These decisions are based on the criterion for evaluation—whether it is typical for a design or a manufacturing and test process. An engineer may want to use test data within the specification limits to evaluate the effectiveness of the product design. In another case, the engineer may elect to use all test data to evaluate the effectiveness of the design in conjunction with the measurement process: test instrument or test equipment, test software, and/or manufacturing and test process.

Once the data is parsed, stored, characterized, and analyzed, the processed data will be maintained in random access memory and the statistical values of every assessed parameter displayed in a Graphical User Interface (GUI). Individual or Multiple Scorecards may be created and displayed by the SAS.

At this time, the user may elect to have the scorecard data undergo further evaluation using additional statistical tools. These tools will evaluate the test data using a myriad of statistical methods (i.e. Capability Analysis, Gage R&R, Analysis of Variation (ANOVA), Design of Experiments (DOE), Time Series, etc.) to provide the engineer with a practical and graphical view of the evaluation.

One of the most important measures of product reliability is “Mean Time between Failures” (MTBF). This information is typically not easily available and, therefore, the benefits of this information are difficult to measure. Therefore, by measuring and displaying the “Scorecard Analysis” over time periods, the user can measure the effectiveness of the product, test instruments, test equipment, test software, and test measurements as applicable.

In one embodiment, the statistical percentiles are calculated based on sampled parameters. For example, all measurements of a parameter are added together and divided by the total number of units measured in the sample to generate the mean and standard deviation for continuous data. In turn, these values are used to calculate the other statistical values (i.e. Z-scores, predicted yield, predicted defects per unit, etc.) For attribute parameters, the comparison of pass/fail criterion are evaluated in the sample to generate the value of the parts per million. In turn, these values determine a predicted defect per unit calculation.

Top Level Process Flowchart

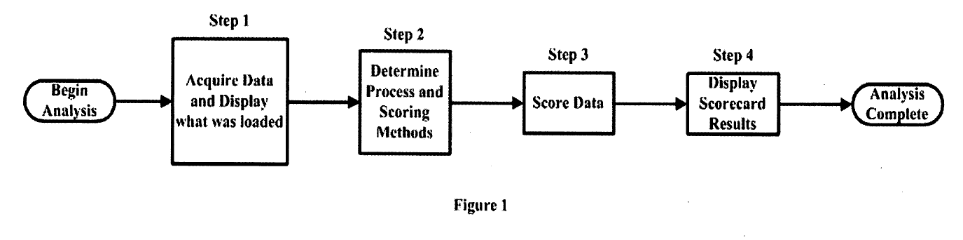

FIG. 1 is a top level flowchart that depicts a method for characterizing and analyzing test data, calculating statistical results, and displaying them via a graphical user interface according to a preferred embodiment of this invention. This method analyzes many test result parameters and data and provides statistical calculations based on the assessed parameter and data.

This process flowchart describes the actions required to evaluate a design parameter from a test perspective. The test could typically be, but not limited to, a design engineer characterizing and evaluating their design, a test in production, or a test regarding a fielded product, service improvement, raw material improvement, etc.

There are four core parts in this process as depicted in FIG. 1. These parts include data acquisition and display of test files that have been acquired, determining the process for characterization and evaluation, determining the scoring method as well as scoring the data using statistical calculations, and displaying the calculation results as a scorecard.

More specifically, the parser is attached to the SAS and the test data file path and file names, with extensions, are acquired and displayed as indicated in step 1. The file names, with extensions, are displayed to ensure they are of the same file type. Step 2 determines the process for characterization and scoring, which include: process method selection, scoring method selection, and scorecard file names selection. The user needs to determine which process method to select: all data or passed data only. Typically, all data is used to fully characterize the product and the passed data only is typically used by engineering to characterize the product from a design perspective since it characterizes continuous data that are within the specification limits. The next task the user must determine is which scoring method to select, individual or grouped characterization, which determines how many scorecards are generated. The grouped scoring method will produce a single scorecard for all selected product part numbers with their respective revision levels. The individual scoring method produces a separate scorecard for each selected product part number with its respective revision level to characterize the product with its respective revision level individually. The grouped scoring method will characterize all of the selected files into a single scorecard, or grouped together as a single entity. The final task for the user is select which product file names, or product file(s) with its/their respective revision level, they want to process. Once these selections are made we can score the data in step 3.

In step 3, the processing method and scoring method selections will determine how the scorecards are to be processed once the user scores the data. The SAS will automatically process the data and generate the scorecard(s).

Once these part numbers with their respective revision levels are evaluated and characterized, the scorecard will display the calculation results, preferably for continuous data it would be the mean, standard deviation, lower Z-score, upper Z-score, yield, and defects per unit; and for attribute data it would be the parts per million and defects per unit in step 4. These calculations provide statistical values based on the measured value averages, or mean, to determine the statistical capability of the parameter. The displayed quantitative test data will typically include the parameter's test number, test description, units, and the test parameter statistical values are calculated using the mean and parametric limits including standard deviation, lower Z-Score, upper Z-Score values, yield, and defects per unit based on the parameter's actual test results measurement data.

Detailed Process Flowchart

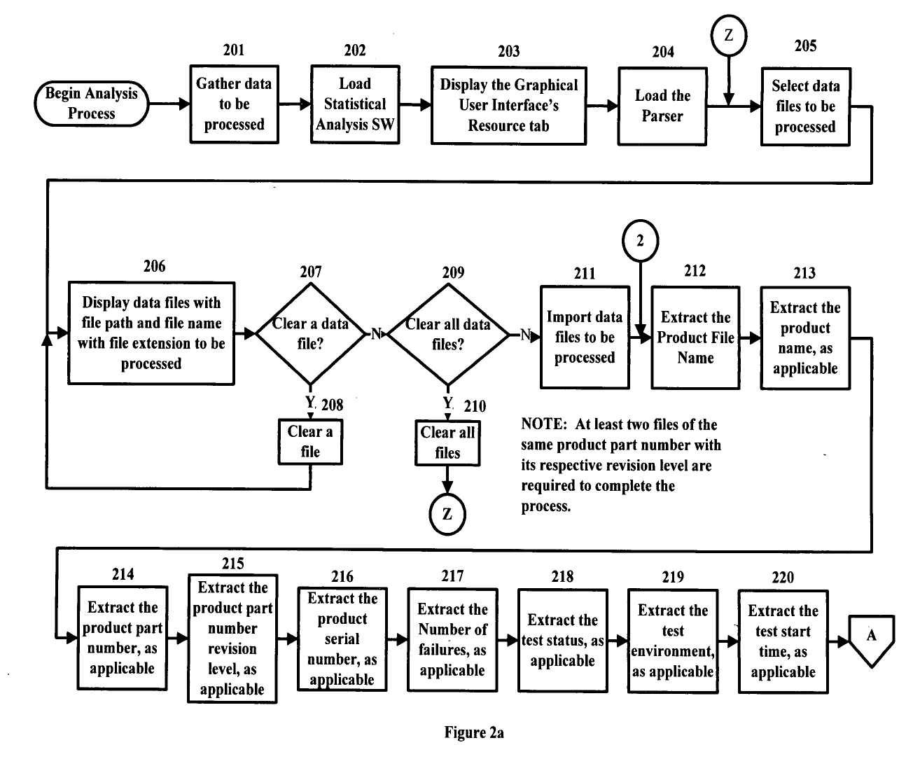

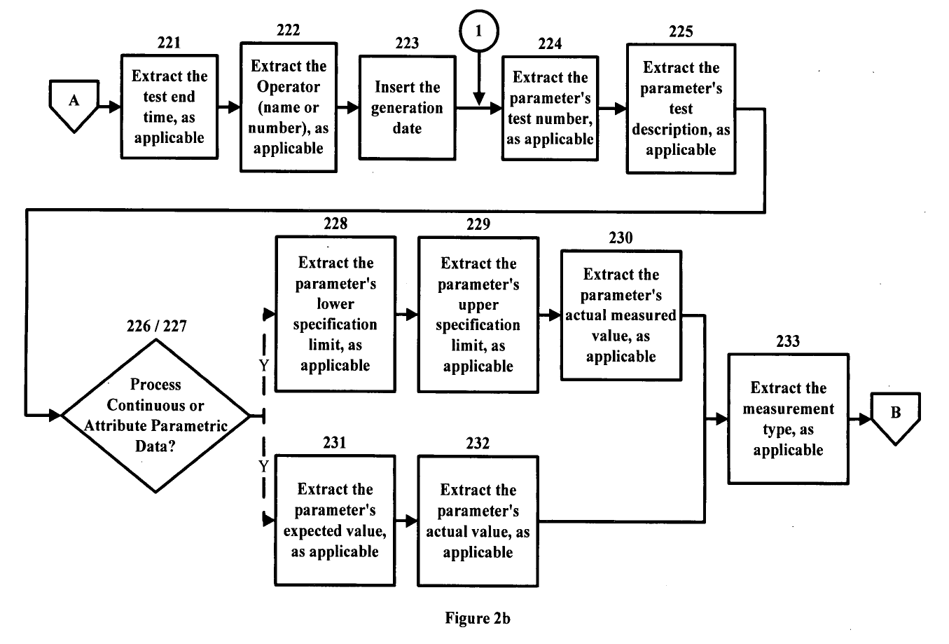

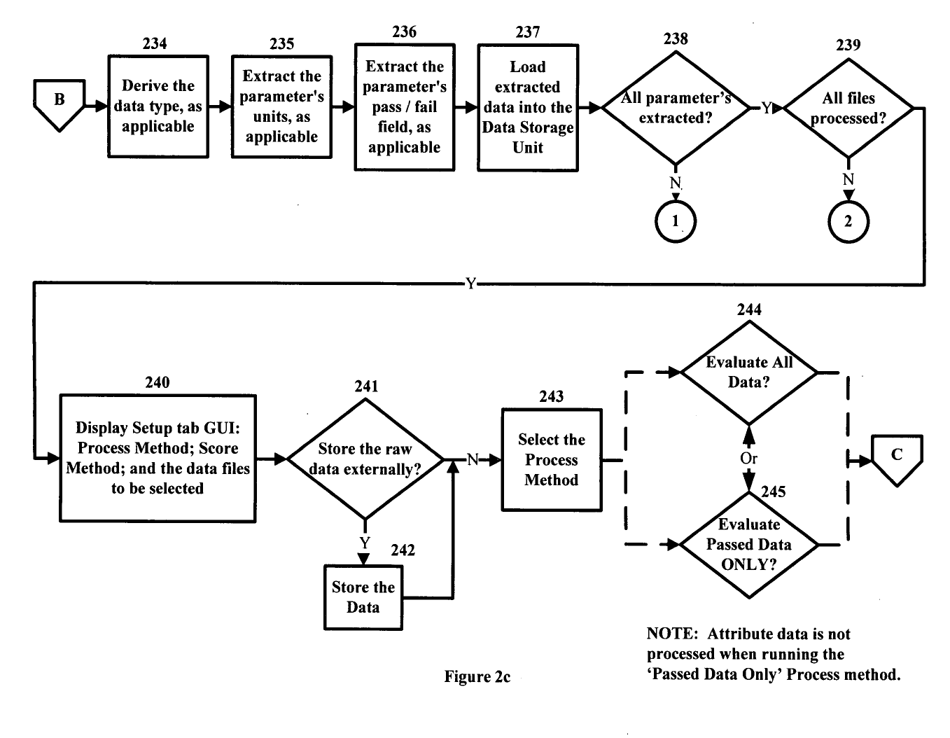

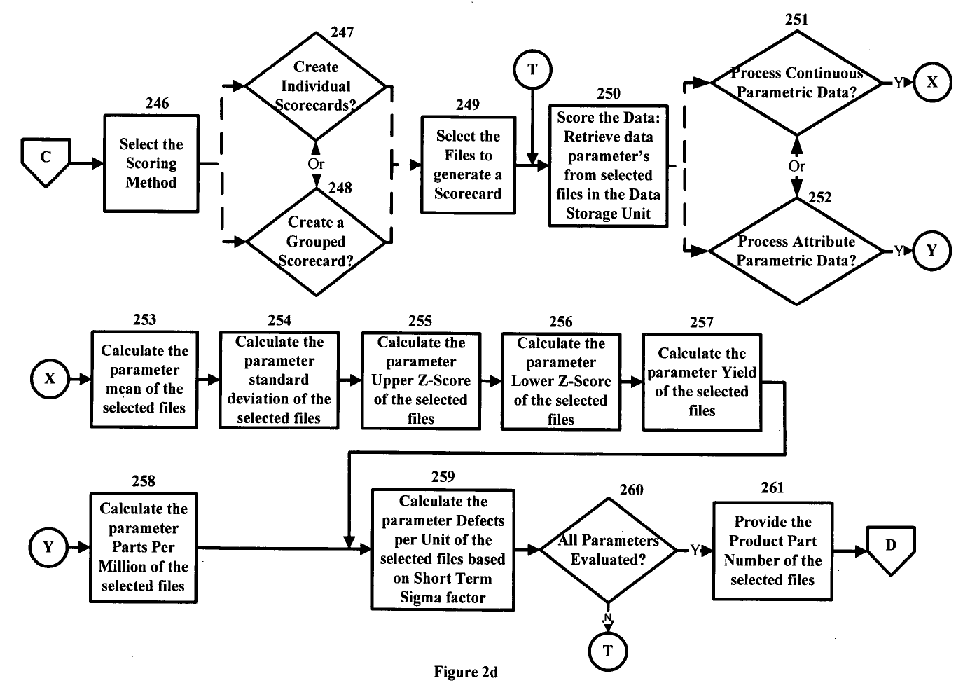

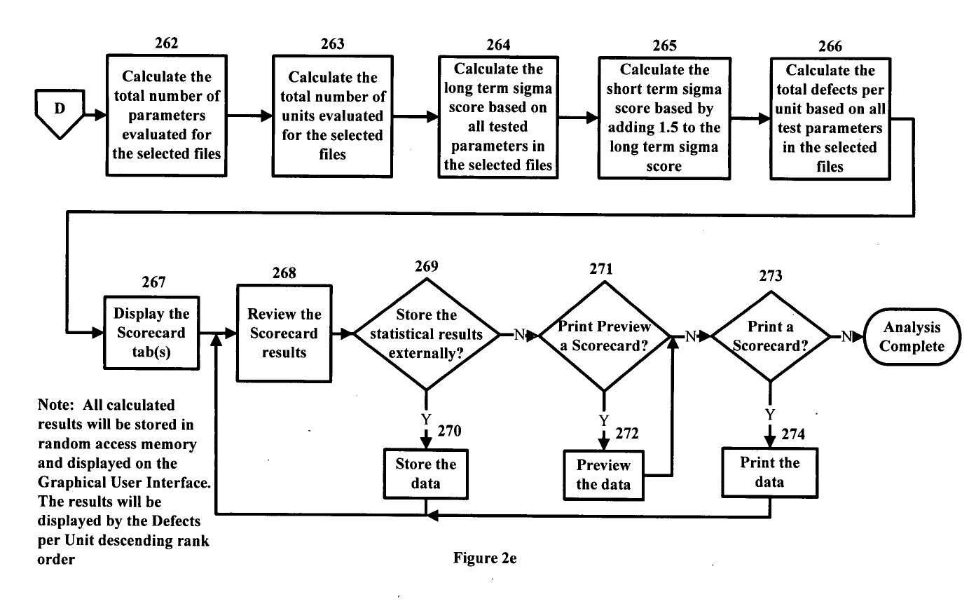

The detailed flowcharts in the FIGS. 2a through 2e disclose an intricate method for capturing, characterizing and analyzing data, calculating statistical results, and displaying them via a graphical user interface according to a preferred embodiment of the present invention. This method characterizes and analyzes a plurality of data values and provides statistical calculations based on assessed parameters.

These process flowcharts describe the actions required to evaluate a product, service, raw material, performance metrics, etc. from a data parameter perspective.

Step 201. Collect and Aggregate Data Files

Aggregate data files from one or various sources for characterization and analysis. These data files may include, but are not limited to, raw data, processed data, process software information; test data, test environment information; test software information and the like. Data includes, but is not limited to, measured items such as test data, design data, performance metrics, financial data, legal data, medical data, service information, performance metrics, etc. Manually collected data files must be converted into an electronic format for processing.

Step 202: Loading Statistical Analysis Software

Load statistical analysis software (SAS) into computer memory for use.

The SAS allows an operator to process the electronic data into a scorecard characterization useful for analysis. In an alternative embodiment, the SAS may be loaded into computer memory prior to the step of data collection.

Step 203: Initiate Software: Display Software GUI of the Resource Tab

Initiate SAS. A SAS Graphical User Interface (GUI) will be displayed on the computer monitor, preferably in a multiple tab format. A resource tab will be displayed on top with its respective menu bar, buttons, product file list box, and status bar. There are also setup and scorecard tabs, which are viewed with their underlying screens behind the resource tab GUI.

Step 204: Load Parser

Load a parser software program into program memory. The parser is developed for disparate test data file formats so the data is extracted correctly. The parser also determines the file extension that is to be processed as well as determining if the extracted data is attribute or continuous data. When the data specification limits are not the same, then it determines the data is continuous. When the data specification limits are the same or there is an expected value, then the parser determines the data is attribute data. However, this determination is proven during parser development when the data is scrutinized to build the parser.

The parser program is preferably dynamically linked to the SAS program. Parser programs are designed to separate data into specific data components and stored in a data storage unit. These components may include test number, test description, lower specification limit, upper specification limit, actual measured value, unit of measure, pass/fail field for continuous (quantitative) data; and expected value, actual value, unit of measure, and pass/fail field for attribute (qualitative) data. It is important to include the expected and actual values or pass/fail field for attribute data for correct processing.

Step 205: Data File Selection

Select computer data files containing the data to be parsed into the data storage unit. The data file extension format is selected during parser development and determines which file extensions must be brought into the SAS. The data must have a matching file extension to the parser or they cannot be selected for processing. If no data files are selected, then terminate program.

Step 206: Display of Data Files in GUI

Display the selected data files in the GUI. Information displayed about these data files preferably includes the file paths and file names with file extensions.

Step 207: Selected Data Files for Removal

Once the selected data files are displayed in the GUI, determine if any of the selected data files should be removed from the characterization and analysis process. If data files are selected for removal, proceed to step 208. If no data files are selected for removal, proceed to Step 209.

Step 208: Remove Data Files

Remove the selected data file from the data file list of files for processing. Return to Step 206.

Step 209: Remove All Data Files

Determine if all files should be removed from the list. If all files are to be removed from the list, proceed to Step 210. If no data files are to be removed from the list, proceed to Step 211.

Step 210: Remove all Data Files

Remove all data files. Return to Step 205 to select another set of files to be processed. If no data files are selected for the characterization and analysis process, then terminate program.

Step 211: Import Data Files for Parsing Import each selected file into memory for subsequent parsing. This step is repeated until all selected files have been parsed.

Step 212: Extract and Store Process File Name

Extract the file name, using the parser, from each data file being processed and store it in the data storage unit.

Step 213: Extract and Store Product Part Name

If available, extract a product part name from the file being processed and store in the data storage unit. Not all files being processed contain a product name and, therefore, the product name may be blank.

Step 214: Extract and Store Product Part Number

If available, extract a product part number from the file being processed and store in the data storage unit. Not all files being processed contain a product part number and, therefore, the product part number may be blank.

Step 215. Extract and Store Product Part Number Revision Level

If available, extract a product part number revision level from the file being processed and store in the data storage unit. Not all files being processed contain a part number revision level and, therefore, the part number revision level may be blank.

Step 216: Extract and Store Product Serial Number

If available, extract a product serial number from the file being processed and store in the data storage unit. Not all files being processed contain a serial number and, therefore, the serial number may be blank.

Step 217: Extract and Store Number of Test Failures

If available, extract the number of test failures from the file being processed and store in the data storage unit. Not all files being processed contain a number of test failures and, therefore, the number of test failures may be blank.

Step 218: Extract and Store Test Status

If available, extract the test status from the file being processed and store in the data storage unit. Not all files being processed contain a test status and, therefore, the test status may be blank.

Step 219: Extract and Store the Test Environment

If available, extract the test environment from the file being processed and store in the data storage unit. The test environment could be used to indicate an initial test, a final test, or other environs such as environmental stress screening, thermal cycle, or vibration. This list of test environs is not all inclusive. Not all files being processed contain a test environment and, therefore, the test environment may be blank.

Step 220: Extract and Store the Test Start Time

If available, extract the test start time from the file being processed and store in the data storage unit. Not all files being processed contain a test start time and, therefore, the test start time may be blank.

Step 221: Extract and Store the Test End Time

If available, extract the test end time from the file being processed and store in the data storage unit. Not all files being processed contain a test end time and, therefore, the test end time may be blank.

Step 222: Extract and Store Operator Information

If available, extract the operator name or number from the file being processed and store into the data storage unit. Not all files being processed contain operator information and, therefore, the operator information may be blank.

Step 223: Generate and Store Generation Time and Date

Generate a current date and time and store into the data storage unit.

Step 224: Extract and Store Test Number

If available, extract the parameter's test number and store in the data storage unit. Not all files being processed contain a test number and, therefore, the test number may be blank.

Step 225: Extract and Store Test Description

If available, extract the parameter's test description and store into the data storage unit. Not all files being processed contain a test description and, therefore, the test description may be blank.

Step 226/227: Determine Data Status

The program will determine if the variables in the file being parsed are continuous or attribute data. The parser is constructed to assess each parameter. When the parameter specification limits are the same or missing, then it is determined that this parameter is attribute data. When the parameter specification limits are not the same, then it is determined that the parameter is continuous data. This determination is accomplished by assessing the specification limits: if the limits are not the same value, then the program ascertains the parameter to be continuous data; and when the limits are the same value, blank, or there is a value in the expected field, then the program determines the parameter to be attribute data. However, this is further determined during parser development when the parser developer evaluates the test data. If the parameter is continuous data, it will perform steps 228 through 230 and steps 233 through 236. If the parameter is attribute data, it will perform step 231 through 236.

Step 228: Extract and Store Continuous Data Lower Specification Limit

For continuous data, the parameter's lower specification limit is extracted from the file being processed and stored in the data storage unit. Not all files being processed contain a continuous data lower specification limit and, therefore, the continuous data lower specification limit may be blank.

Step 229: Extract and Store Continuous Data Upper Specification Limit

For continuous data, the parameter's upper specification limit is extracted from the file being processed and stored into the data storage unit. Not all files being processed contain a continuous data upper specification and, therefore, the continuous data upper specification may be blank.

Step 230: Extract and Store Actual Measured Values

For continuous data, a parameter's actual measured values are extracted from the file being processed and stored into the data storage unit. The actual measured value is a numeric value that is typically provided by a measurement device. The actual measured value must be present to be processed, characterized, and analyzed.

Step 231: Extract and Store Expected Value

For attribute data, a parameter's expected value is extracted from the file being processed and stored into the data storage unit. The expected value could be, but is not limited to, a response (i.e. yes/no, on/off), digital word, or other data form that is binary in nature. Not all files being processed contain an expected value and, therefore, the expected value may be blank. If the Expected Value is blank, then the pass/fail field in step 236 must be present for the parameter to be processed.

Step 232: Extract and Store Attribute Actual Value

For attribute data, a parameter's actual value is extracted from the file being processed and stored into the data storage unit. The actual value must equal the expected value in Step 225 to meet the pass criterion. Not all files being processed contain an actual value and, therefore, the actual value may be blank. If the actual value is blank, then the pass/fail field in step 236 must be present for the parameter to be processed.

Step 233: Derive and Store Measurement Type

For both continuous and attribute data, the measurement type is derived from the parameter being processed and inserted into the data storage unit. A parameter's measurement type could mean different things to users. For example, measurement types could be Boolean, Value, Data, etc. Not all files being processed contain a measurement type and, therefore, the measurement type may be blank.

Step 234: Derive the Data Type

For both continuous and attribute data, the data type is derived from step 226/227 in the parameter being processed and inserted into the data storage unit. A parameter's data type is defined as either attribute data or continuous data. There are occasions where the data is not identifiable (i.e. corrupted data). When this occurs, the program will output a ‘Not a Number’. This enables the user to peruse the data to determine which file caused the problem, remove or correct the file, and reprocess the data.

Step 235:Extract and Store a Parameter s Units

For both continuous and attribute data, the parameter's units are extracted from the file being processed and inserted into the data storage unit. Not all files being processed contain a parameter's units and, therefore, the parameter's units may be blank.

Step 236: Pass/Fail Field

For both continuous and attribute data, the parameter's pass/fail field is extracted from the file being processed and inserted into the data storage unit. A parameter would pass the pass/fail field if the actual value equals the expected value for attribute data or meets the conditions set by the upper and lower specifications, as applicable, for continuous data. Not all products or services will have a pass/fail field assigned in the file being processed and, therefore, the pass/fail criterion may have to be derived from the expected/actual data (attribute) or meet the specification limits (continuous). However, the expected and actual values or the pass/fail field must be present to effectively process attribute data, and the measured value must meet the specification limits for continuous data.

Step 23 7: Data Processing into the Data Storage Unit

Process all the extracted data from the file and insert the data into the data storage unit.

Step 238: Parameter Extraction

Determine if the parser has extracted all the parameters in the current file and continue processing until the end of file is achieved. However, the parser does not determine if there are missing parameters in a file. Data integrity is the responsibility of the user. If not, repeat steps 224 through 237 until all parameters have been extracted in the file.

Step 239: Repeat Steps 212-238 until all files have been processed

Determine if all the selected files have been processed into the data storage unit. If not, repeat steps 212 through 238 until all files have been processed and the data is extracted.

Step 240: Update GUI Display Information for Setup Tab

Once all the files have been processed, the SAS automatically displays the setup tab. The product part number, product name, product part number revision level, and the number of product files captured for the product are displayed in the listbox along with selections for the process method and the scoring method.

Step 241: Determination of Optional External Storage of Raw Data

Determine if the user wants to store the raw data externally. If selected, proceed to step 242. Otherwise, proceed to step 243.

Step 242: External Storage of Raw Data

Store the raw data externally, preferably in a comma separated value format. The raw header data typically consists of the product part number, product part number revision level, and serial number. The raw continuous data consists of the lower specification limit, actual measured value, upper specification limit, pass/fail field, and units if the data was captured during the parsing process. The raw attribute data consists of the expected value, actual value, pass/fail field and units if the data was captured during the parsing process. The raw data for both continuous and attribute data would typically include the test number and test description if they were captured during the parsing process.

Step 243: Process Method Determination

Select data processing method, ‘All Data’ or ‘Passed Data ONLY’, for data characterization and analysis.

Step 244. All Data Processing

The evaluation using the ‘All Data’ process method will characterize and analyze the entire data set. The data set consists of parameter data that may be in or out of the specification limits for continuous data or the expected value may or may not match the actual value in attribute data. The characterization and analysis occurs for all data whether the parameter passed or failed. There may be occasions when one or both of the continuous specification limits are purposely not included. In this case, the measured value mean would is derived. If one specification limit is missing, that limit's particular Z-Score is not determined. If both specification limits were missing, the mean is calculated and all the other statistical values are blank.

Step 245: Passed Data Processing

The evaluation using the ‘Passed Data ONLY’ process method will characterize and analyze only the data that is within the specification limits for continuous data. The characterization and analysis of the ‘Passed Data ONLY’ occurs on data that only meets the pass criterion. There may be occasions when one or both of the continuous specification limits are purposely not included. In this case, the measured value mean is derived. If one specification limit is missing, that limit's particular Z-Score is not determined. If both specification limits were missing, the mean is calculated and all the other statistical values are blank.

Step 246: Scoring Method Determination

Select scoring method, ‘Individual’ or ‘Grouped’, for data characterization and analysis.

Step 247: Individual Scoring

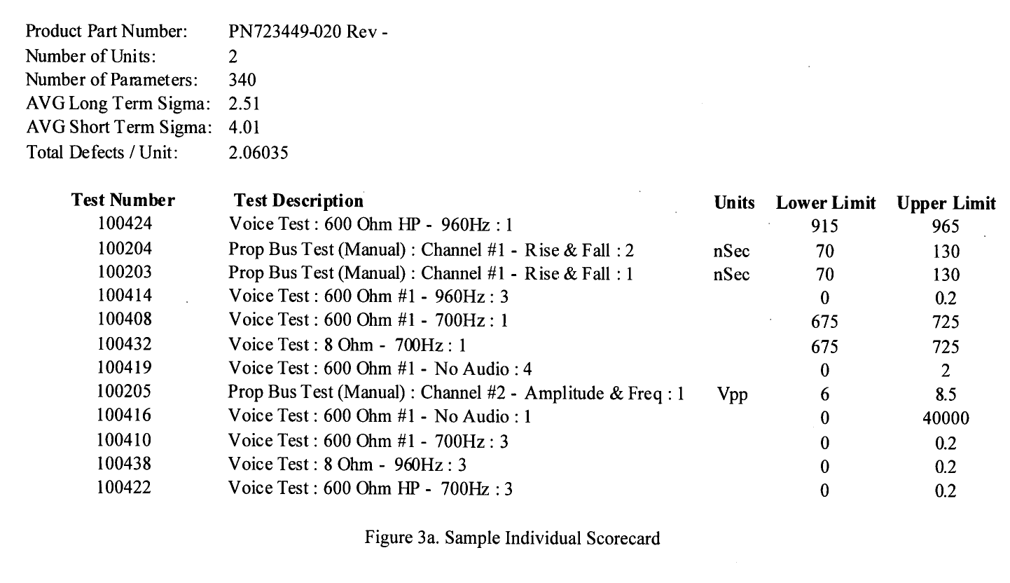

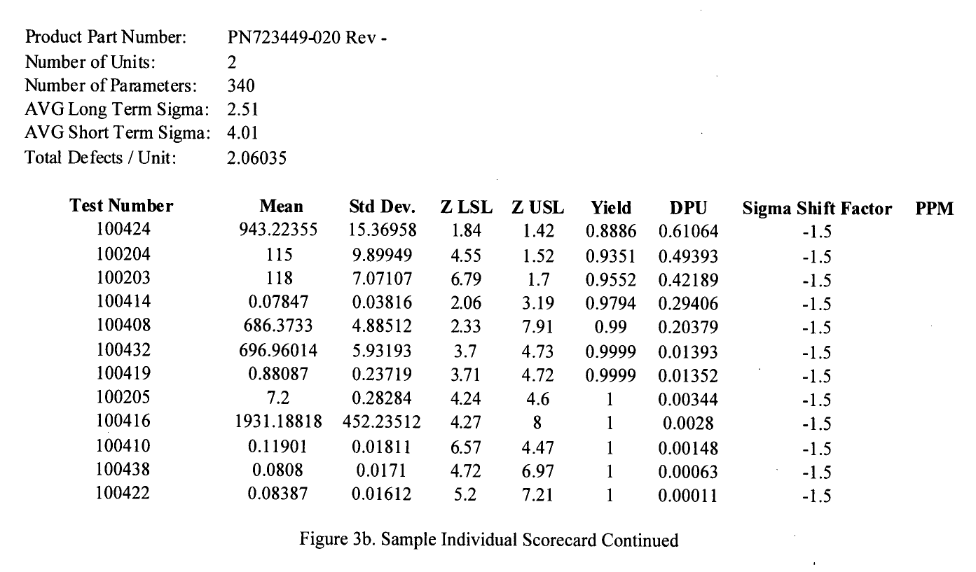

The ‘Individual’ scoring method produces a separate scorecard for each selected product part number with its respective revision level for characterization and analysis as described in FIG. 3.

Step 248: Group Scoring

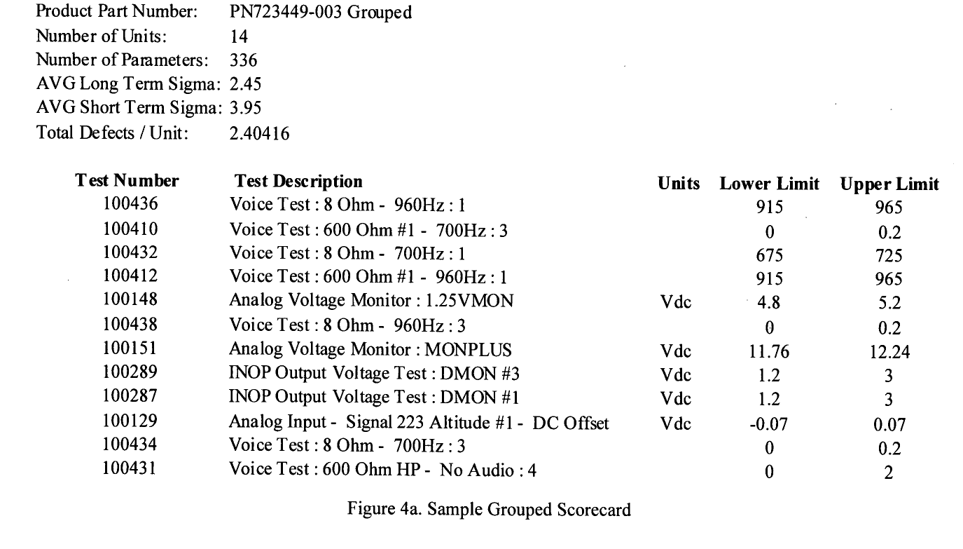

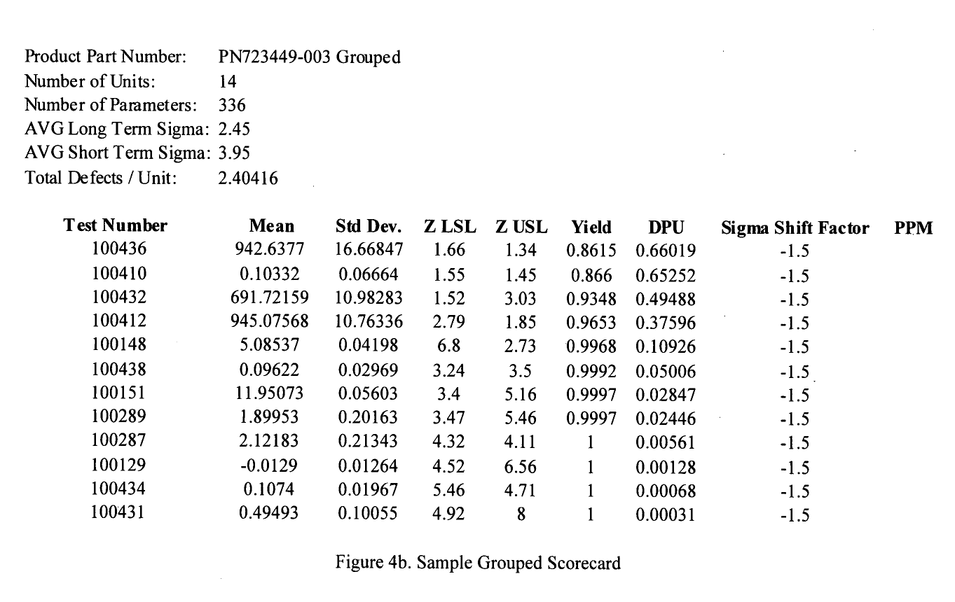

The ‘Grouped’ scoring method produces a single scorecard for all selected product part numbers with their respective revision levels for characterization and analysis as described in FIG. 4.

Step 249: Scorecard File Selection

The product part numbers, product names, revision levels, and number of product files are in a listbox with a checkbox for selection. Select the checkbox for the product part numbers that are to be processed into the scorecard(s). The selected files will be processed according to the process method and scoring method selections above.

Step 250: Score the Data

Characterize and analyze the data by scoring the data and creating a scorecard for the products with their respective revision levels that were selected in the process and scoring methods as indicated in FIG. 3 for the individual scorecard and FIG. 4 for the grouped scorecard. The selected files are retrieved from the data storage unit and processed accordingly. The user needs to determine which process method to select: all data or passed data only. The user must also determine which scoring method to select, individual or grouped characterization, which determines how many scorecards are generated.

Prior to this invention, product failures were only reviewed. This thought process lead to incorrect assumptions about the parameters that failed and give a false sense that failed areas were indicative of the root cause for that failure. This invention characterizes the entire product to determine areas for improvement whether the parameter passed or failed. This allows the user to ascertain root cause of the failure, if any, more effectively and efficiently. Or, the user may elect to improve the product that did not fail, but bases improvement on the outcome of a high DPU.

FIG. 3 and FIG. 4 are sample scorecards as described. Both figures provide the data with the defects per unit (DPU) in descending order to indicate the parameters with the highest potential for failure or highest rate of failure. A high DPU is indicative of potential parameter problems within the product. FIG. 3 is an individual scorecard and FIG. 4 is a grouped scorecard. FIG. 3 is a review of a product with the same part number and revision level. FIG. 4 is a review of all related products with no regard for the revision level. The data in both are presented in the way data should be reviewed. The scorecard layout allows the user to review the data logically.

In FIG. 3, the individual scorecard allows the user to review the data specifically for the product revision to gain insight about the design and determines if any of the parameters are in need of improvement. The user will be able to focus on the parameters that could potentially be problematic to the overall effectiveness of the design for that particular revision level.

In FIG. 4, the grouped scorecard review is determined by the user since they may select any or all of the related products to generate this combined scorecard. With this selection, insight is gained regarding the product family to ascertain if there has been improvement in the overall product. Essentially, this review helps to determine if parameters continue to be in need of improvement.

Step 251: Determine if Continuous Data is to be Processed into a Scorecard

The SAS checks if the parameter data is a continuous type. If the parameter is continuous, it proceeds to steps 253, 254, 255, 256, 257, and step 259, and store the results into the Random Access Memory (RAM) accordingly. Continuous (quantitative) data will be processed differently from the attribute (qualitative) data. The data statistical values are calculated and stored in RAM, sorted by the defects per unit ranking order and displayed once all parameters have been calculated and stored in RAM.

Step 252: Determine if Attribute Data is to be Processed into a Scorecard

The SAS checks if the parameter data is an attribute type. If the parameter is attribute data, it proceeds to step 258 and step 259 and store the results into Random Access Memory accordingly.

Step 253: Calculate Parameter Mean

For continuous data, characterize and analyze the parameter's mean from the list of captured files in the data storage unit as selected in step 249 in conjunction with the scoring method selection in step 247 or step 248. The mean (arithmetic average) is the sum of all the observations divided by the number of observations. The parameter's mean is then stored into random access memory.

Step 254: Calculate Parameter Standard Deviation

For continuous data, the parameter's standard deviation is derived from the mean. The standard deviation roughly estimates the “average” distance of the individual observations from the mean. While the range of the data estimates the spread of the data by subtracting the minimum value from the maximum value, the greater the standard deviation, the greater the overall spread of the data. The standard deviation is then stored into random access memory.

Step 255: Calculate Parameter Upper Z-score

For continuous data, the parameter's Upper Z-Score, or Z-Value, is derived from the mean and compared to the Upper Specification Limit. There may be occasions when the Upper Specification Limit is not included. In this case, the Upper Z-Score is not determined and is blank. The Upper Z-Score measures how far an observation above the mean lies from the mean, in the units of standard deviation. The Upper Z-Score is then stored into random access memory, as applicable.

Step 256: Calculate Parameter Lower Z-score

For continuous data, the parameter's Lower Z-Score, or Z-Value, is derived from the mean and compared to the Lower Specification Limit. There may be occasions when the Lower Specification Limit is not included. In this case, the Lower Z-Score is not determined and is blank. Again, the Lower Z-Score measures how far a lower observation lies below its mean, in the units of standard deviation. The Lower Z-Score is then stored into random access memory, as applicable.

Step 257: Calculate Parameter Yield

For continuous data, the parameter's Yield, or percentage of parameters that are within the specification limits, is derived from both the Lower Z-Score and Upper Z-Score, unless one is missing. If this is the case, then yield will be determined by the remaining Z-Score. The Yield (percentage) number is then stored into random access memory.

Step 258: Calculate Parts Per Million (PPM)

For attribute data, the parameter's Parts Per Million (PPM) is derived from the number of actual parameters that meet the expected value, in the pass/fail field, multiplied by one million and divided by the total number of measurements for this parameter. The PPM number is then stored into random access memory. This step will not be used if the ‘Passed Data ONLY’ is selected in the Process Method (step 245).

Step 259: Calculate Parameter Defects per Unit

For both attribute and continuous data, the parameter's Defects Per Unit (DPU) is calculated by applying PPM and Z-Score respectively and many other factors such as yield and sigma shift factor. The DPU number is then stored into random access memory. DPU is determined by taking the number of defects and dividing them by the total population.

Step 260. Repeat Steps 250-259

If all parameters in the data files have not been processed, then repeat steps 250 through 259 to process the continuous or attribute parameters. If not, return to step 250 and repeat the process. If all the parameters have been processed, then proceed to the step 261.

Step 261: Product Part Number Displayed

The product part number is determined by the selection in step 249, extracted from the data stored in the data storage unit, processed in RAM, and displayed in the Scorecard GUI.

Step 262: Total Number of Parameters Characterized and Analyzed

Calculate the total number of parameters for each product part number with its respective revision level of the files that were characterized and analyzed for the Scorecard.

Step 263. Total Number of Product Files Characterized and Analyzed

Calculate the total number of product files for each product part number with its respective revision level of the files that were processed. If the individual scoring method was selected (step 247), then each selected product part number will have its own total number of units. Otherwise, calculate the total number of units for all products if the grouped scoring method was selected (step 248).

Step 264: Calculate Long-Term Sigma Score

The long-term sigma score is based on the total yield for each product part number with its respective revision level of the files that were processed. The overall yield is calculated by adding each of the parameter's yield for the Scorecard. Then perform a probability distribution calculation to determine the long-term sigma score.

Step 265: Calculate Short-Term Sigma Score

Calculate the overall short-term sigma score by adding 1.5 to the long-term sigma score of the scorecard. Again, there may be multiple scorecards if a plurality of products were selected for individual scoring and one scorecard if the grouped scoring method is selected.

Step 266: Calculate Total Number of Defects

Calculate the total number of defects per unit by adding all the defects per unit of all the processed parameters for the product part number with its respective revision level files. There may be multiple scorecards if a plurality of products were selected for individual scoring and one scorecard if the grouped scoring method is selected.

Step 267: Display Scorecard Tab

Display the characterizations of all parameters for each product part number with its respective revision level. These characterizations are based on the process and scoring methods and ready to be analyzed. Multiple scorecards would be displayed if more than one product number with its respective revision level is selected and the individual scoring method is selected. Only one scorecard will be displayed if the grouped scoring method is selected.

Step 268: Review Scorecard Results

Review and analyze the displayed scorecard(s) parameter characterizations for each product part number with its respective revision level. The number of scorecards displayed is based on the scoring method. Multiple scorecards would be displayed if more than one product part number with its respective revision level is selected and the individual scoring method is selected. The scorecards are viewed on different screens in the GUI. Only one scorecard would be displayed on the GUI if the grouped scoring method is selected as described in FIG. 4.

FIG. 3 and FIG. 4 provide the data with the defects per unit (DPU) in descending order. This order provides insight into the parameters with the highest potential for failure since a high DPU is indicative of problems in a product. The scorecard data is reviewed logically by looking at the specification limits initially for continuous data. Once the specification limits are reviewed, the actual measured data mean, standard deviation, Z-Lower and Z-Upper, Yield, defects per unit (DPU), and sigma shift factor are reviewed respectively in the stated order. The attribute data is reviewed by looking at the defects per unit and parts per million calculations and are based on the total number units checked versus the number of failed units. The attribute and continuous data are not segregated. The worst defects per unit values are provided in descending order no matter which data type they are: attribute data or continuous data.

The specification limits are reviewed first to determine if they are correct as well as seeing how they relate to the statistical calculations.

The mean is reviewed next to determine how the actual data compares to the specification limits.

The standard deviation is then reviewed to determine if it will fall outside the specification limits since we add 3 standard deviations to each side of the mean and check to see how they compare to the specification limits.

The Z-lower and Z-upper values are the sigma scores against each of the specification limits. If a specification limit is not use, then the corresponding Z-value will be blank.

The calculated yield predicts the number of times the parameter's actual measurement will fall within the specification limits using normal distribution.

The defects per unit (DPU) of both attribute data and continuous data are calculated, and are in descending order to quickly view the worst scoring parameters. Remember the closer the DPU value is to one (1) the higher the probability there is a problem with that parameter. Therefore, the highest DPU values are indicative of a potential problem and should be reviewed first.

The attribute data parts per million calculations are reviewed. The calculation indicates the number of failures for the parameter with respect to the captured data.

Step 269: Determine External Storage of Statistical Results

Determine if the user wants to store the parametric results externally. If selected, proceed to step 270. Otherwise, continue to review and analyze the scorecard(s).

Step 270: External Storage of Statistical Results

The data is exported and stored in a comma separated value format. This process may be performed for each scorecard generated and displayed in the GUI.

Step 271: Determine Print Preview for Scorecard(s)

Determine if the user wants to print preview the parametric data of a scorecard. If selected, proceed to step 272. Otherwise, continue to review and analyze the scorecard(s). Note that this process will need repeated for each scorecard printed.

Step 272: Preview the Scorecard Data

The user will view the data and has the option to close the previewing screen or print the data.

Step 273: Print Scorecard

Determine if the user wants to print the currently displayed parametric results of the scorecard. This process will need to be repeated for each scorecard generated and displayed in the GUI. If selected, proceed to step 274. Otherwise, continue to review and analyze the scorecard(s).

Step 274: Determine Print Status

Determine if the user wants to print the data. The user has the option to print and return to review and analyze the parameters or close the printing option to review and analyze the parameters.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A method for data analysis comprising the steps of:
a) Providing test data;
b) Selecting either pass only data or all data;
c) processing the selected data; and
d) displaying either the mean, standard deviation, lower Z-score, upper Z-score, yield, and defects per unit or the parts per million and defects per unit.

2. A method for data analysis comprising the steps of:
a) Collecting and aggregating data files;
b) Loading statistical analysis software;
c) Initiating software and displaying software graphical user interface of a resource tab;
d) Loading parser;
e) Selecting data files to be processed;
f) Displaying of selected data files in the graphical user interface;
g) Selecting data files for optional removal;
h) Optionally removing selected data files for optional removal;
i) Optionally removing all data files and returning to step e above or termination software;
j) Importing data files for parsing;
k) Parsing data files by extracting and storing product part name into a data storage unit;
l) Parsing data files by extracting and storing product part number into the data storage unit;
m) Parsing data files by extracting and storing product part number revision level into the data storage unit;
n) Parsing data files by extracting and storing product serial number into the data storage unit;
o) Parsing data files by extracting and storing number of test failures into the data storage unit;
p) Parsing data files by extracting and storing test status into the data storage unit;
q) Parsing data files by extracting and storing test environment into the data storage unit;
r) Parsing data files by extracting and storing test start time into the data storage unit;
s) Parsing data files by extracting and storing test end time into the data storage unit;
t) Parsing data files by extracting and storing operator information into the data storage unit;
u) Parsing data files by extracting and storing generation time and date into the data storage unit;
v) Parsing data files by extracting and storing test number into the data storage unit;
w) Parsing data files by extracting and storing test description into the data storage unit;
x) Parsing data files by extracting and storing data status into the data storage unit;
y) Parsing data files by extracting and storing continuous data lower specification limit into the data storage unit;
z) Parsing data files by extracting and storing continuous data upper specification limit into the data storage unit;
aa) Parsing data files by extracting and storing actual measured values into the data storage unit;
bb) Parsing data files by extracting and storing expected values into the data storage unit;
cc) Parsing data files by extracting and storing attribute actual values into the data storage unit;
dd) Parsing data files by extracting and storing data type into the data storage unit;
ee) Parsing data files by extracting and storing parameters units into the data storage unit;
ff) Parsing data files by extracting and storing pass/fail field into the data storage unit;
gg) Repeat steps k-ff for each data file selected;
hh) Updating graphical user interface display information;
ii) Selecting a data processing method from either all data or passed data only;
jj) For all data, characterizing and analyzing the entire data set;
kk) For pass data only, characterizing and analyzing passed data only within the specification limits for continuous data;
ll) Selecting a scoring method from individual or grouped;
mm) For individual scoring; a separate scorecard is produced for each selected product part number with its respective revision level;
nn) For grouped scoring; a single scorecard is produced for all selected product part numbers with their respective revision levels;
oo) Determining if continuous or attribute data is being processed;
pp) For continuous data, calculating each parameter's mean and store into the data storage unit;
qq) For continuous data, calculating each parameter's standard deviation and store into the data storage unit;
rr) For continuous data, calculating each parameter's upper Z-Score or Z-Value and store into the data storage unit;
ss) For continuous data, calculating each parameter's lower Z-Score or Z-Value and store into the data storage unit;
tt) For continuous data, calculating each parameter's yield and store into the data storage unit;
uu) For attribute data, calculating each parameters parts per million and store into the data storage unit;
vv) For attribute data, calculating each parameters defects per unit and store into the data storage unit;
ww) Calculating the total number of parameter for each product part number that were processed;
xx) Calculating the total number of product files for each product part number that were processed;
yy) Calculating the long-term sigma score for each product part number that were processed;
zz) Calculating the short-term sigma score for each product part number that were processed;
aaa) Calculating the total number of defects per unit for each product part number;
bbb) Displaying scorecard or scorecards; each scorecard comprising:
ccc) For continuous data; specification limits, the actual measured data mean, standard deviation, Z-Lower and Z-Upper, Yield, defects per unit (DPU), and sigma shift factor;
ddd) For attribute data; defects per unit and parts per million;
eee) Determining whether to store the statistical results externally;
fff) Terminating software.
